(19) United States
(12) Patent Application Publication
(10) Pub. No.: US 2012/0162616 A1
(43) Pub. Date: Jun. 28, 2012

(54) PROJECTOR WITH EYE PROTECTION MECHANISM

(75) Inventors: BING-HENG LEE, Tu-Cheng (TW); YI-ZHONG SHEU, Tu-Cheng (TW); TAI-CHERNG YU, Tu-Cheng (TW)

(73) Assignee: HON HAI PRECISION INDUSTRY CO., LTD., Tu-Cheng (TW)

(21) Appl. No.: 13/048,883

(22) Filed: Mar. 16, 2011

(30) Foreign Application Priority Data
Dec. 28, 2010 (TW) 99146196

(51) Int. Cl. G03B 21/14

(52) U.S. Cl. 353/97

(57) ABSTRACT

A projector includes a case, a projection lens, a shielding plate, and a controller received in the case. The case includes a sidewall defining an aperture. The projection lens is used for projecting a cone of light rays which passes through the aperture and a projection area. The shield plate is positioned on the sidewall. The driver is used for driving the shield plate to any of desired positions ranging from a first position in which the shield plate exposes the aperture to a second position in which the shield plate shields the aperture. The barrier detection device is used for generating a first signal if detecting no barrier presents in the projection area and generating a second signal if detecting a barrier presents in the projection area. The controller is used for controlling the driver to drive the shield plate to the first position if receiving the first signal.

### BACKGROUND

1. Technical Field

The present disclosure relates to projectors and, particularly, to a projector having eye protection function.

2. Description of Related Art

A projection area is formed between a projector and a screen. If a user enters the projection area when the projector is being operated, light rays from the projector could hurt the eyes of the user.

Therefore, it is desirable to provide a projector with an eye protection mechanism that can overcome the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure.

FIG. 1 is a schematic view of a projector, according to an exemplary embodiment.

FIG. 2 is similar to FIG. 1, but viewed from another angle.

FIG. 3 is similar to FIG. 2, but showing another state of the projector.

FIG. 4 is a schematic view of an assembly plate of the projector of FIG. 1.

FIG. 5 is a functional block diagram of a barrier detection device of the projector of FIG. 1.

### DETAILED DESCRIPTION

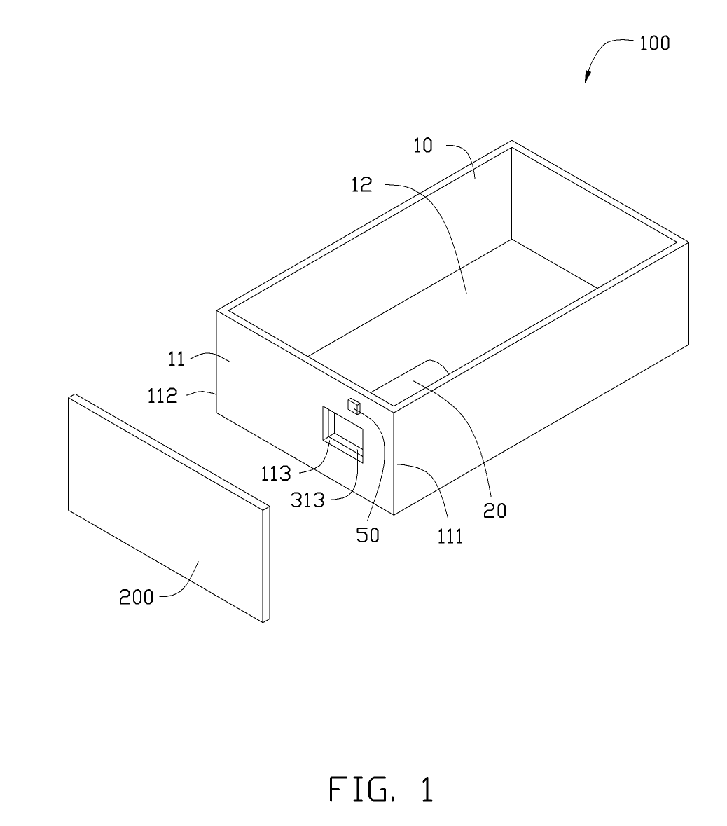

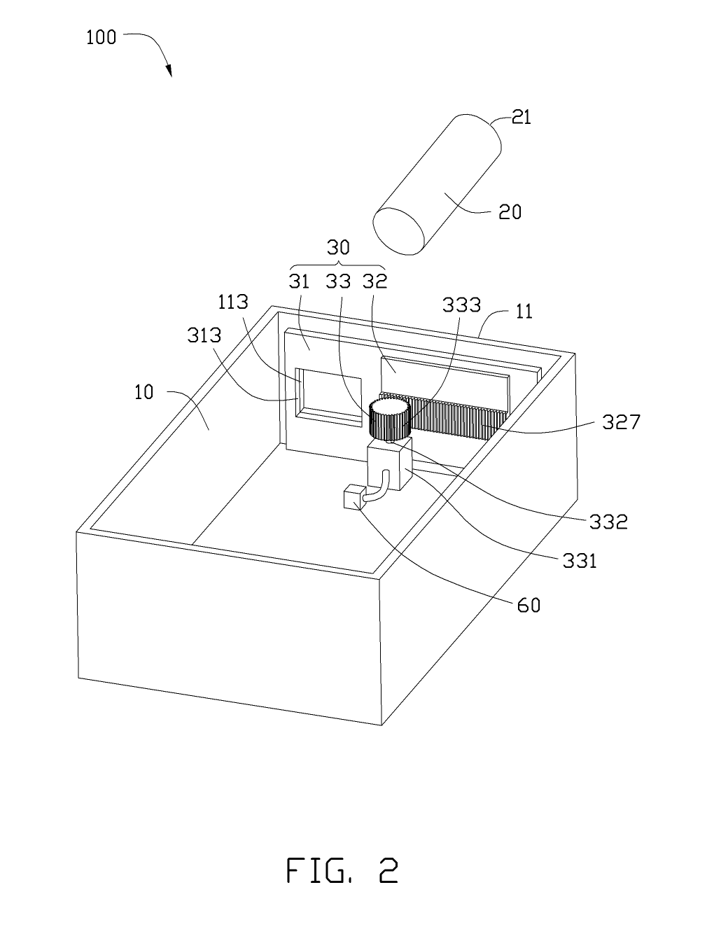

Referring to FIG. 1 and FIG. 2, a projector 100, according to an exemplary embodiment, includes a casing 10, a projection lens 20, a shielding device 30, a barrier detection device 50, and a controller 60. In this embodiment, the projector 100 is a laser projector.

The casing 10 is substantially a hollow cuboid in shape, and includes a sidewall 11 and a bottom plate 12 perpendicularly connecting to the sidewall 11. The sidewall 11 includes a first side 111 and a second side 112 opposite to the first side 111. The sidewall 11 defines an aperture 113 adjacent to the first side 111.

The projection lens 20 is received in the casing 10 and projects a cone of light rays that carry image signals to a screen 200, thus forming enlarged images on the screen 200. When the projector 100 is in operation, a projection area that the cone of light rays passes is formed between the projector 100 (e.g., the projection lens 20) and the screen 200. The projection lens 20 includes a light outlet surface 21 from which the cone of light rays emits. The light outlet surface 21 faces and is aligned with the aperture 113.

The shielding device 30 is received in the casing 10 and includes an assembly plate 31, a shield plate 32, and a driver 33.

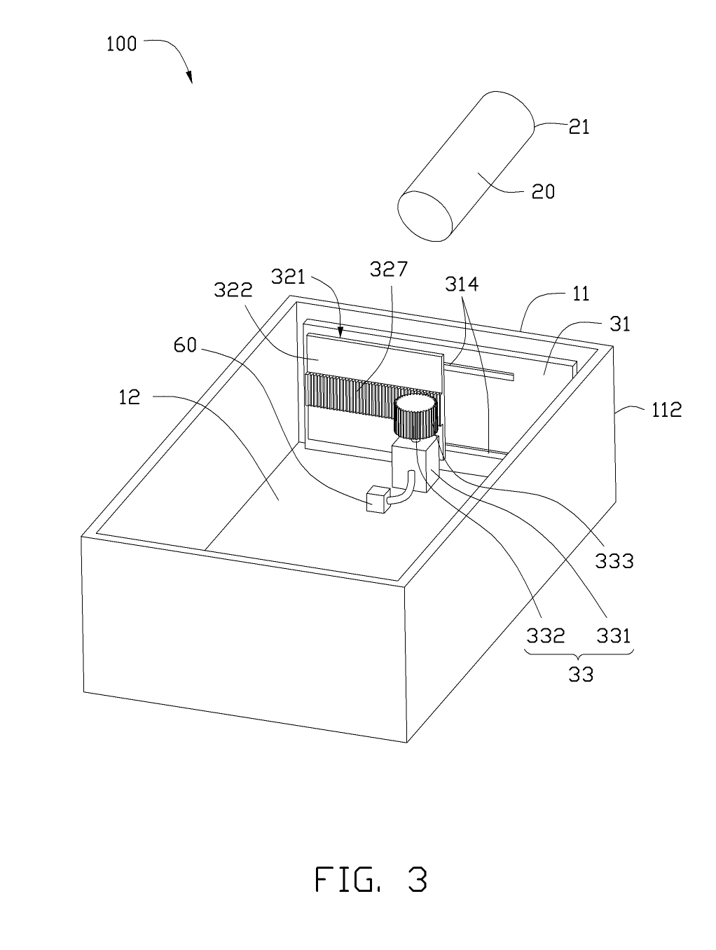

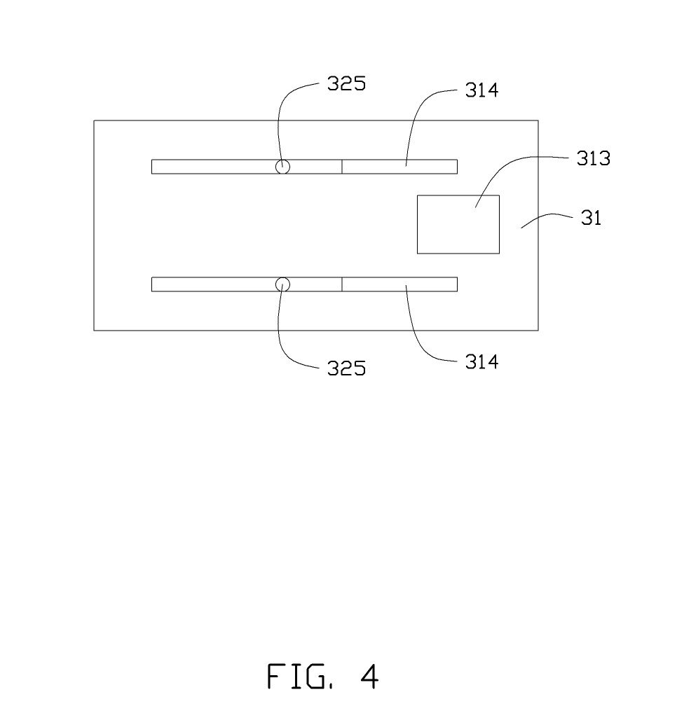

Referring also to FIGS. 3 and 4, the assembly plate 31 is substantially rectangular, and defines two sliding slots 314 along the lengthwise direction thereof and a through hole 313 adjacent to a short edge thereof corresponding to the aperture 113. The two sliding slots 314 extend through the assembly plate 31 along the thick direction thereof.

The shield plate 32 is also substantially rectangular and is disposed on a surface of the assembly plate 31 away from the sidewall 11. The shield plate 32 includes a connecting surface 321 and a shielding surface 322 opposite to the connecting surface 321. Two rods 325 protrude outwards from the connecting surface 321 corresponding to the sliding slots 314. A rack 327 is formed on the center of the shielding surface 322 and extends along the lengthwise direction of the shield plate 32.

The driver 33 is received in the casing 10 and used for driving the shield plate 32 to slide on the assembly plate 31 along the sliding slots 314, and includes a motor 331 and a rotating shaft 332 rotatably coupled to the motor 331. The circumferential surface of the rotating shaft 332 is toothed and gears 333 are formed thereon. The gears 333 mesh with the rack 327.

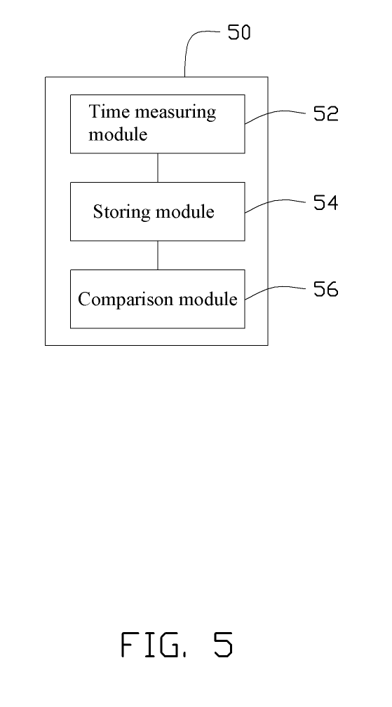

Referring also to FIG. 5, the barrier detection device 50 is used for checking whether or not a barrier (e.g., a person or an object) is present in the projection area. The barrier detection device 50 includes a time measuring module 52, a storing module 54, and a comparison module 56.

The time measuring module 52 emits a beam of measuring light rays (not shown) toward the screen 200 and receives the beam of light rays which is reflected back from the screen 200 or a barrier, if any, and thus calculates an actual transmission time of the beam of measuring light rays. In this embodiment, the measuring light rays are infrared light rays.

The storing module 54 initializes a reference transmission time and stores the reference transmission time, according to actual operating conditions of the projector 100. In particular, the reference transmission time is a period of time that the beam of light rays travels from the barrier detection device 50 to the screen 200 and is reflected back to the barrier detection device 50, and is a basis used to determine whether a barrier is present in the projection area.

The comparison module 56 compares an actual transmission time with the reference transmission time and generates a first signal and a second signal according to comparison results. In particular, when the actual transmission time is equal to the reference transmission time, the first signal, which indicates that no barrier is located in the projection area, is generated. When the actual transmission time is shorter than the reference transmission time, the second signal, which indicates that a barrier enters into the projection area, is generated.

The controller 60 is electrically connected to the driver 33 and the barrier detection device 50 and used for controlling the motor 331 to drive the shield plate 32 to slide along the sliding slot 314 if receiving the actuating signal.

In assembly, the shielding device 30 is received in the casing 10, the assembly plate 31 is attached to the inner surface of the sidewall 11, and the through hole 313 is aligned with the aperture 113. The two rods 325 of the shield plate 32 are slidably received in the two sliding slots 314, with each rod 325 received in a corresponding sliding slot 314. The driver 33 is disposed on the bottom plate 12, the rack 327 meshing with the gear 333 of the driver 33. The projection lens 20 is received in the casing 10, the light outlet surface 21 is aligned with the through hole 313. The barrier detection device 50 is mounted on an outer surface of the sidewall 11 adjacent to the aperture 113. The controller 60 is electrically connected to the motor 331 and the barrier detection device 50.

In use, when the barrier detection device 50 generates the first signal, which indicates that no barrier is located in the projection area, the controller 60 controls the motor 331 to drive the shield plate 32 to slide away from the through hole 313 to open the aperture 113. When the barrier detection device 50 generates the second signal, which indicates that a barrier has entered into the projection area, the controller 60 controls the motor 331 to drive the shield plate 32 to slide toward the through hole 313 to shield the aperture 113.

In this embodiment, the area of the aperture 113 is substantially equal to that of the through hole 313, but larger than that of the light outlet surface 21. In other embodiments, the area of the aperture 113 also can be greater than or less than that of the through hole 313.

In other embodiments, the sliding slot 314 also can be only defined on a surface of the assembly plate 31 facing the shield plate 32. The number of the sliding slots 314 also can be one, and accordingly, the number of the rods 325 can be one. The motor 331 also can be disposed on other portion of the casing 10, for example, another sidewall adjacent to the sidewall 11. The time measuring module 52 can also emit an ultrasonic wave to calculate the actual transmission time. The actual transmission time is a period time that the ultrasonic wave transmits from the time measuring module 52 to the screen 200 or the barrier and is reflected by the screen 200 or the barrier back to the time measuring module 52. The reference transmission time is a period of time that the ultrasonic wave transmits from the time measuring module 52 to the screen 200 and is reflected by the screen 200 back to the time measure module 52.

In other embodiments, the assembly plate 31 also can be omitted, and the sliding slots 314 are defined in the sidewall 11.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A projector comprising:
a casing comprising a sidewall, the sidewall defining an aperture;
a projection lens received in the casing and aligned with the aperture, the projection lens configured for projecting a cone of light rays, the light rays passing through the aperture and a projection area and irradiating on a screen, the projection area positioned between the projection lens and the screen;
a shield plate positioned on the sidewall;
a driver connected to the shield plate and capable of driving the shield plate to any of desired positions ranging from a first position in which the shield plate exposes the aperture to a second position in which the shield plate shields the aperture;
a barrier detection device positioned on an outer surface of the sidewall and configured for generating a first signal if detecting no barrier presents in the projection area and generating a second signal if detecting a barrier presents in the projection area; and
a controller electrically connected to the driver and the barrier detection device and configured for controlling the driver to drive the shield plate to the first position if receiving the first signal from the barrier detection device and controlling the driver to drive the shield plate to the second position if receiving the second signal from the barrier detection device.

2. The projector of claim 1, comprising an assembly plate positioned on an inner surface of the sidewall and defining a through hole corresponding to the aperture, the shield plate slidably positioned on a surface of the assembly plate away from the sidewall.

3. The projector of claim 2, wherein the casing further comprises a bottom plate substantially perpendicular to the sidewall, the assembly plate is substantially rectangular, and defines at least one sliding slot along a direction substantially parallel to the bottom plate, the shield plate comprises a connecting surface facing the assembly plate, and at least one rod protruding outwards from the connecting surface, the at least one rod is slidably received in the at least one sliding slot.

4. The projector of claim 3, wherein the shield plate comprises a shielding surface opposite to the connecting surface, and a rack positioned on the shielding surface and extending substantially parallel to the at least one sliding slot; the driver comprises a toothed rotating shaft, and the toothed rotating shaft meshes with the rack.

5. The projector of claim 4, wherein the driver further comprises a motor, the motor is connected to the toothed rotating shaft and configured for driving the toothed rotating shaft to rotate.

6. The projector of claim 5, wherein the driver is positioned on the bottom plate.

7. The projector of claim 1, wherein the barrier detection device comprises a time measuring module, a storing module, and a comparison module, the time measuring module is configured for emitting a beam of measuring light rays toward the screen and receiving the beam of measuring light rays which is reflected by the screen or the barrier, thus to calculate an actual transmission time that the beam of measuring light rays transmits from the time measuring module and back to the time measuring module, the storing module is configured for storing a reference transmission time, the reference transmission time is a period of time that the beam of measuring light rays transmits from the time measuring module to the screen and back to the time measuring module, the comparison module is configured for comparing the actual transmission time with the reference transmission and generating the first signal if the actual transmission time is equal to the reference transmission time and generating the second signal if the actual transmission time is shorter than the reference transmission time.

8. The projector of claim 1, wherein the barrier detection device comprises a time measuring module, a storing module, and a comparison module, the time measuring module is configured for emitting an ultrasonic wave toward the screen and receiving the ultrasonic wave which is reflected by the screen or the barrier, thus to calculate an actual transmission time that the ultrasonic wave transmits from the time measuring module and back to the time measuring module, the storing module is configured for storing a reference transmission time, the reference transmission time is a period of time that the ultrasonic wave transmits from the time measuring module to the screen and back to the time measuring module, the comparison module is configured for comparing the actual transmission time with the reference transmission and generating the first signal if the actual transmission time is equal to the reference transmission time and generating the second signal if the actual transmission time is shorter than the reference transmission time.

9. The projector of claim 1, wherein the projector is a laser projector.
